(19) United States
(12) Patent Application Publication
(10) Pub. No.: US 2004/0219919 A1
(43) Pub. Date: Nov. 4, 2004

(54) Management of uplink scheduling modes in a wireless communication system

(76) Inventors: Nicholas Whinnett, Marlborough (GB); Amitava Ghosh, Buffalo Grove, IL (US); Ravi Kuchibhotla, (US); Robert Love, Barrington, IL (US)

Correspondence Address: MOTOROLA, INC., 1303 EAST ALGONQUIN ROAD, IL01/3RD, SCHAUMBURG, IL, 60196

(21) Appl. No.: 10/427,358

(22) Filed: Apr. 30, 2003

(51) Int. Cl. H04Q 7/20

(52) U.S. Cl. 455/442; 455/436; 455/435.1

(57) ABSTRACT

The present invention provides an advantageous method for transitioning reliably between scheduling modes on an uplink in a wireless communication system. Transitions between scheduling modes are effected as far as possible using signaling between a wireless communication device and a base station, providing low delay transitions in the majority of cases. Advantageously, signaling direct between the wireless communication device and a network control element may be employed. In addition, the method may operate effectively even when the wireless communication device is in communication with a number of base stations in a soft handoff situation because the network control element may act to ensure that all base stations correspond to the current scheduling mode employed by the wireless communication device.

### FIELD OF THE INVENTION

The present invention relates to scheduling of uplink transmissions in a wireless communication system. In particular, the invention relates to the management of transitions between uplink transmission scheduling modes in a wireless communication system.

### BACKGROUND OF THE INVENTION

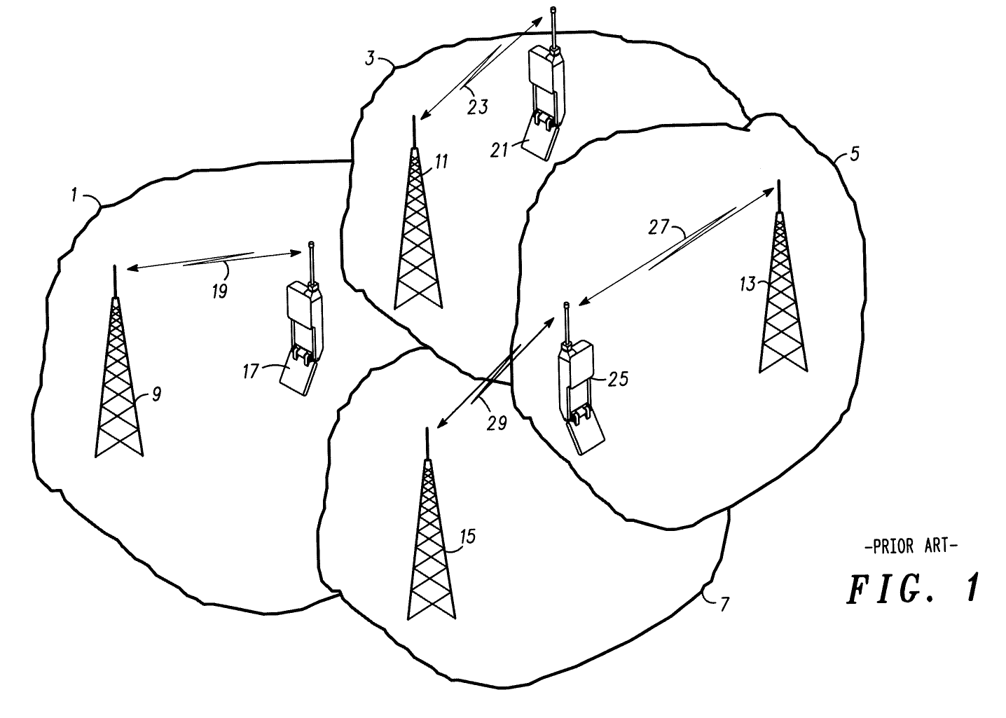

FIG. 1 illustrates the principle of a conventional cellular communication system in accordance with prior art. A geographical region is divided into a number of cells 1, 3, 5, 7 each of which is served by base station 9, 11, 13, 15. The base stations are interconnected by a fixed network that communicates data received from higher layers to the base stations 9, 11, 13, 15. A mobile station is served via a radio communication link by the base station of the cell within which the mobile station is situated. In the example of FIG. 1, mobile station 17 is served by base station 9 over radio link 19, mobile station 21 is served by base station 11 over radio link 23 and so on.

As a mobile station moves, it may move from the coverage of one base station to the coverage of another, i.e. from one cell to another. For example mobile station 25 is initially served by base station 13 over radio link 27. As it moves towards base station 15 it enters a region of overlapping coverage of the two base stations 13 and 15 and within this overlap region it is supported by base station 15 over radio link 29. As the mobile station 25 moves further into cell 7, it continues to be supported by base station 15. This is known as a handover or handoff of a mobile station between cells.

A cellular communication system extends coverage over typically an entire country and comprises hundreds or even thousands of cells supporting thousands or even millions of mobile stations. Communication from a mobile station to a base station is known as uplink, and communication from a base station to a mobile station is known as downlink.

The fixed network interconnecting the base stations is operable to route data between any two base stations, thereby enabling a mobile station in a cell to communicate with a mobile station in any other cell. In addition the fixed network comprises gateway functions for interconnecting to external networks such as the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

Currently, the most ubiquitous cellular communication system is the 2^{nd} generation communication system known as the Global System for Mobile communication (GSM). GSM uses a technology known as Time Division Multiple Access (TDMA) wherein user separation is achieved by dividing frequency carriers into 8 discrete time slots, which individually can be allocated to a user. Further description of the GSM TDMA communication system can be found in ‘The GSM System for Mobile Communications’ by Michel Mouly and Marie Bernadette Pautet, Bay Foreign Language Books, 1992, ISBN 2950719007.

Currently, 3^{rd} generation systems are being rolled out to further enhance the communication services provided to mobile users. The most widely adopted 3^{rd} generation communication systems are based on Code Division Multiple Access (CDMA) wherein user separation is obtained by allocating different spreading and scrambling codes to different users on the same carrier frequency. The transmissions are spread by multiplication with the allocated codes thereby causing the signal to be spread over a wide bandwidth. At the receiver, the codes are used to de-spread the received signal thereby regenerating the original signal. Each base station has a code dedicated for a pilot and broadcast signal. An example of a communication system using this principle is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

One feature of CDMA systems such as UMTS is that the mobile station (called a User Equipment (UE) in UMTS language) is able simultaneously to be in signaling and data contact with a number of base stations (called node Bs in UMTS language) for a period of time, not just when moving from one cell to another cell as described above. This situation is called soft handover or soft handoff. The UE keeps a list of the node Bs with which it is associated i.e. the base stations with which it is in contact in an active set. While in soft handover, the UE will therefore have more than one node B in the active set.

Generally uplink transmissions in a wireless communication system are scheduled using an “autonomous scheduling” mode whereby a UE may transmit whenever the UE has data in its transmit buffer and all UEs are allowed to transmit simultaneously. Typically the data rates and powers that can be used by the UE are controlled by the node B. The data rates and powers may be controlled by the node B in a number of ways, for example by way of restrictions in a Transport Format Combination Set imposed by the node B or by use of a Persistence parameter broadcast over the cell, as described by Motorola in co-pending application No. (Motorola docket number CS22879RL)

An Enhanced Uplink Dedicated Transport channel has been proposed for UMTS. A proposed feature of the enhanced uplink is node B controlled uplink scheduling, whereby the node B controls the timing and power of uplink transmissions in such as way as to maximize uplink throughput, while maintaining interference at an acceptable level. Specifically, a node B may schedule the uplink transmission of a UE taking into account the uplink channel conditions, the amount of data waiting to be transmitted and the available transmit power of the UE for example. This type of scheduling is referred to as explicit Node-B scheduling whereby layer 1 (L1) signaling, i.e. signaling between the UE and the node B, is used on both the uplink and downlink in order to grant to a UE specific time intervals and maximum transmit power for that transmission.

Explicit scheduling provides the node B with a higher degree of control than autonomous scheduling, and thus allows the node B to better minimize inter-cell and intra-cell interference and therefore to maximize uplink capacity.

However, this advantage is provided at a cost of increased L1 uplink and downlink signaling requirements for explicit scheduling compared with autonomous scheduling. Therefore, if a UE only has a small amount of data to transmit, it is preferable for autonomous scheduling to be used, since explicit scheduling provides no net improvement in the uplink performance in view of the additional L1 signaling overhead.

Previously it has been suggested that both autonomous mode and explicit mode should be used for the proposed Enhanced Uplink Dedicated Transport channel, the transition between autonomous mode and explicit mode being made based solely on the soft handoff status of the user. Thus a UE in soft handoff (i.e. communicating with a number of node Bs) would use autonomous scheduling while a UE not in soft handoff (i.e. communicating with only a single Node B) would use explicit scheduling.

However, there are a number of disadvantages with this proposal. In particular, high data rate users in soft handoff would use autonomous scheduling which is not efficient and low data rate users not in soft handoff would use explicit mode which is not efficient in view of the signaling overhead. Moreover, no details are proposed of how the mode change from explicit to autonomous and vice versa might be reliably performed.

Additionally it has been proposed that a UE may autonomously transmit up to some rate threshold, beyond which the UE must request a rate from the node B and be explicitly scheduled at that rate by the node B. Again, no mention is made of how the transitions between autonomous mode and explicit scheduling mode would be handled.

Another proposal is that autonomous scheduling and explicit scheduling may operate at the same time. If the UE data buffer occupancy and available power are high enough, the UE requests and the node B grants explicit operation for one frame/sub-frame at a time. The main and significant disadvantage of this approach is that this removes the ability for a node B to decide when a UE should be scheduled. This flexibility is desirable, for example, to allow a node B to schedule a UE when the uplink channel conditions are good (i.e. perform “upfade” scheduling) which offers significant performance benefits.

Therefore there is a need for a method of transitioning between autonomous and explicit scheduling modes, for both the non-soft handover, and the soft handover situation.

The present invention seeks to minimize or alleviate the problems encountered in the prior art.

### SUMMARY OF THE INVENTION

In accordance with one aspect of the invention, there is provided a method of operation in a wireless communication device capable of operating in a first mode in which the wireless communication device schedules uplink transmissions and a second mode in which a base station schedules uplink transmissions, wherein when the wireless communication device is operating in the first mode the method comprising the steps: determining whether operation in accordance with the second mode is required; in response to a determination that operation in accordance with the second mode is required, sending a request for scheduling of uplink transmissions to the or at least one serving base station; entering the second mode if a scheduling message is received from the base station.

According to a second aspect of the invention, there is provided a method of operation in a wireless communication device capable of operating in a first mode in which the wireless communication device schedules uplink transmissions and a second mode in which a base station schedules uplink transmissions, wherein when the wireless communication device is operating in the first mode the method comprising the steps: determining whether operation in accordance with the second mode is required; in response to a determination that operation in accordance with the second mode is required, sending a message to the or at least one serving base station requesting scheduling of uplink transmissions; sending a message requesting second mode operation to a network controller if a scheduling message is not received from the base station.

According to a third aspect of the invention, there is provided a method of operation in a wireless communication device capable of operating in a first mode in which the wireless communication device schedules uplink transmissions and a second mode in which a base station schedules uplink transmissions, wherein when the wireless communication device is operating in the second mode the method comprising the steps: determining whether operation in accordance with the first mode is required; in response to a determination that operation in accordance with the first mode is required, sending a first mode notification message to the or at least one serving base station; transitioning to the first mode.

According to a fourth aspect of the invention, there is provided a method of operation of a base station serving a wireless communication device, the base station being capable of operating in a first mode in which the wireless communication device schedules uplink transmissions and a second mode in which the base station schedules uplink transmissions, wherein when the base station is in the first mode the method comprises the steps: receiving a request for second mode operation from the wireless communication device; scheduling an uplink transmission responsive to the request for second mode operation; and

transitioning to the second mode if a valid uplink transmission is received from the wireless communication device at the scheduled time.

According to a fifth aspect of the invention, there is provided a method of operation of a base station serving a wireless communication device, the base station being capable of operating in a first mode in which the wireless communication device schedules uplink transmissions and a second mode in which the base station schedules uplink transmissions, wherein when the base station is in the second mode the method comprises the steps: determining whether a first mode notification message is received from the wireless communication device; and transitioning to the first mode of operation on receipt of a first mode notification message from the wireless communication device.

According to a sixth aspect of the invention, there is provided a method of operation of a base station serving a wireless communication device, the base station being capable of operating in a first mode in which the wireless communication device schedules uplink transmissions and a second mode in which the base station schedules uplink transmissions, wherein when the base station is in the second mode the method comprises the steps: determining whether a message is received from a radio network controller instructing the base station to transition to the first mode of operation; and transitioning to the first mode if such an instruction is received.

According to a seventh aspect of the invention, there is provided a method of operation of a radio network controller in a wireless communication system, the wireless communication system having at least one base station that, in use, provides communication services to at least one wireless communication device, the at least one base station and the at least one wireless communication device being operable in a first mode in which the wireless communication device schedules uplink transmissions and a second mode in which the base station schedules uplink transmissions, comprising the steps: determining receipt of a message from a wireless communication device in the first mode requesting transition to the second mode; and instructing all base stations associated with the wireless communication device to transition to the second mode in response to the receipt of said message.

According to a eighth aspect of the invention, there is provided a method of operation of a radio network controller in a wireless communication system, the wireless communication system having at least one base station that, in use, provides communication services to at least one wireless communication device, the at least one base station and the at least one wireless communication device being operable in a first mode in which the wireless communication device schedules uplink transmissions and a second mode in which the base station schedules uplink transmissions, comprising the steps: determining receipt of a message from a base station associated with a wireless communication device indicating that the wireless communication device has entered the first or the second mode; and instructing any other base stations associated with the wireless communication device that the wireless communication device has entered the first or second mode.

The invention also provides a storage medium for storing processor-implementable instructions for controlling a processor to carry out the method of the invention.

In addition, the invention also provides wireless communication apparatus for carrying out the method of the invention, Specifically, as described, the invention provides a wireless communication device, a base station, and a network controller for carrying out the method of the invention. However, the method in accordance with the invention may also be distributed across different elements of the communication system.

### BRIEF DESCRIPTIONS OF THE INVENTION

For a better understanding of the present invention, and to show how it may be brought into effect, reference will now be made, by way of example, to the accompanying drawings, in which:

FIG. 1 is a general system diagram of a wireless communication system;

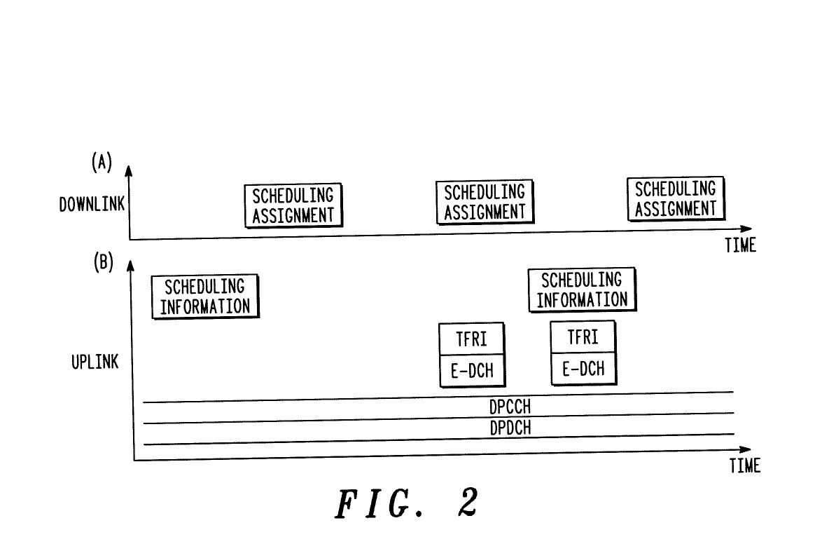

FIG. 2a illustrates signaling on the downlink in accordance with a proposal for explicit scheduling of uplink data transfers;

FIG. 2b illustrates signaling on the uplink in accordance with proposals for explicit scheduling and for autonomous scheduling of uplink data transfers;

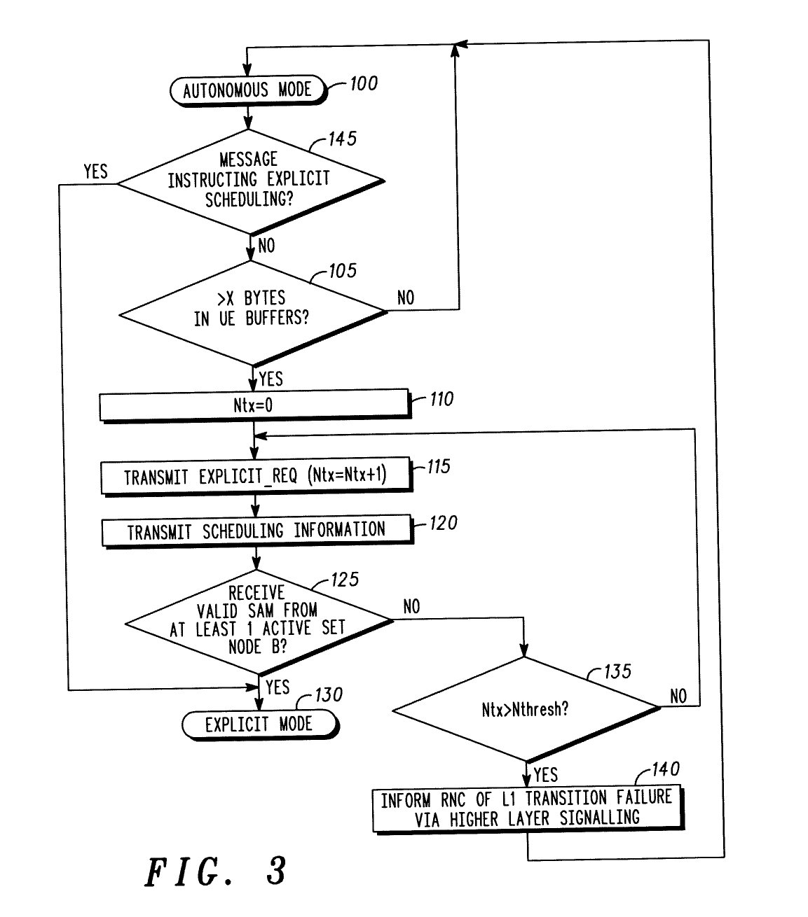

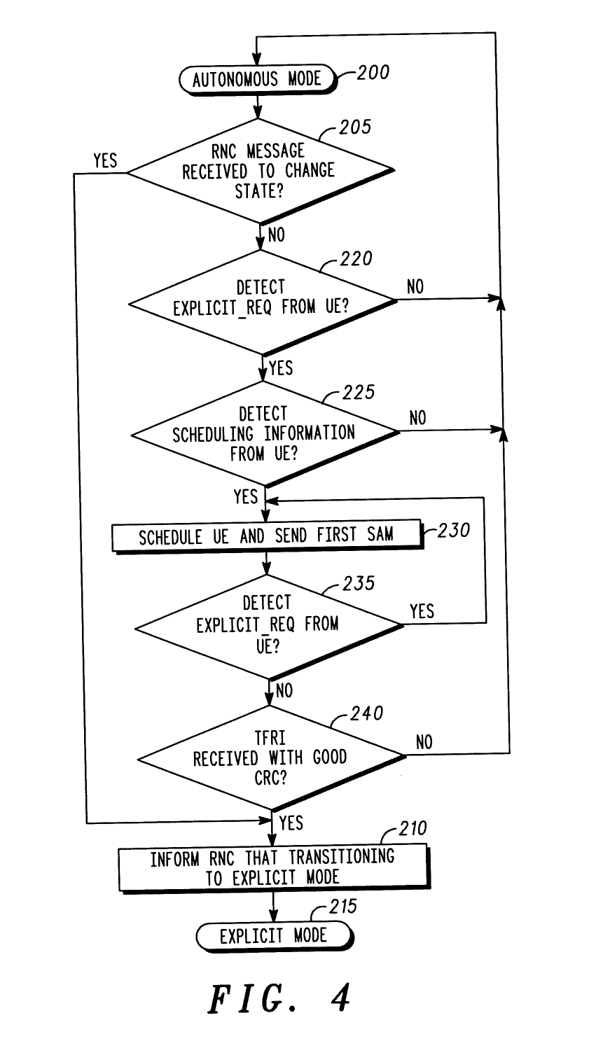

FIG. 3 is a flow diagram explaining a method of operation of a wireless communication device in accordance with a first aspect of the invention;

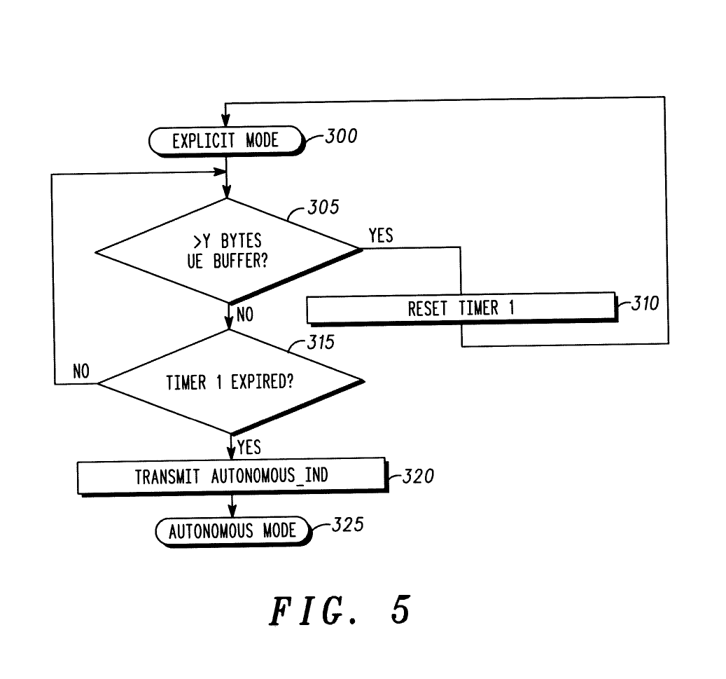

FIG. 4 is a flow diagram illustrating a method of operation of a base station in accordance with a second aspect of the invention;

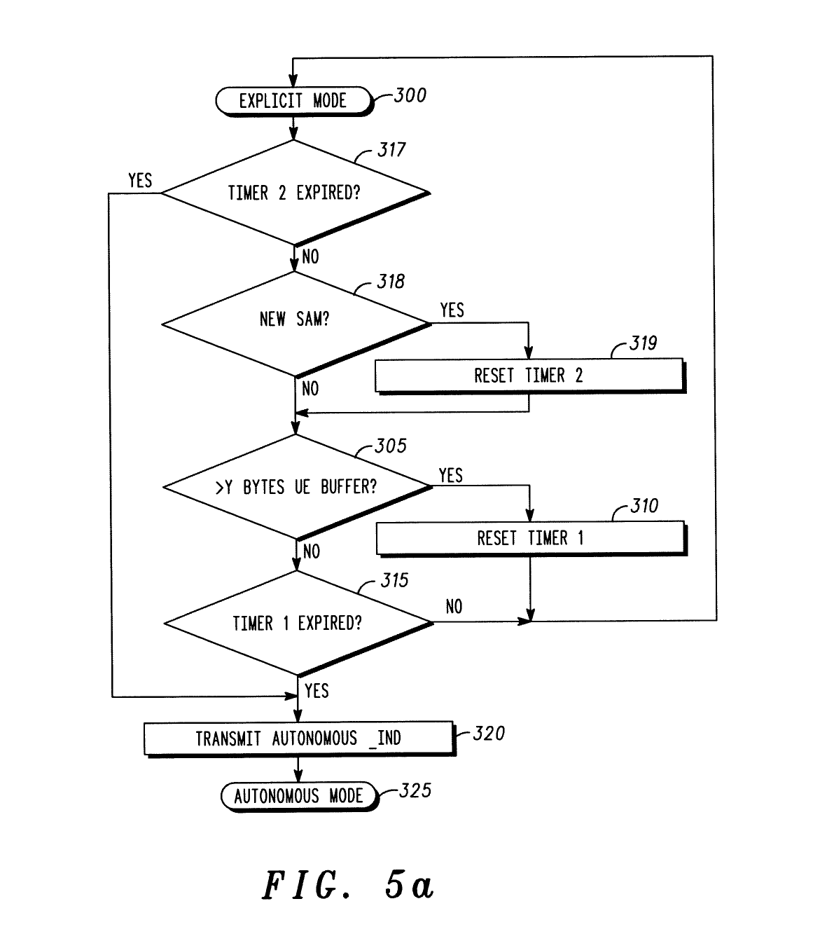

FIG. 5 is a flow diagram illustrating a method of operation of a wireless communication device in accordance with a third aspect of the present invention;

FIG. 5a is a flow diagram illustrating an alternative embodiment of a method of operation of a wireless communication device in accordance with a third aspect of the present invention;

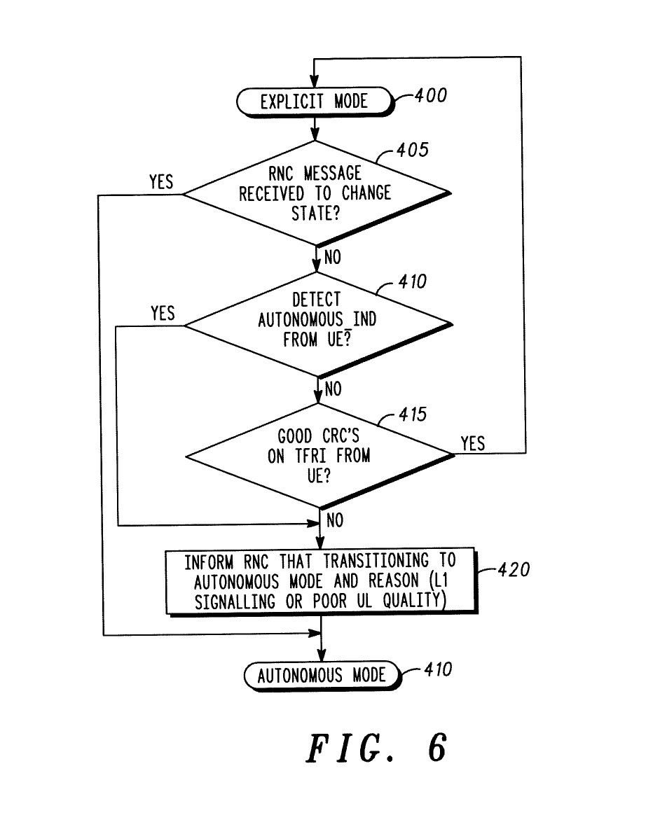

FIG. 6 is a flow diagram illustrating a method of operation of a base station in accordance with a fourth aspect of the present invention;

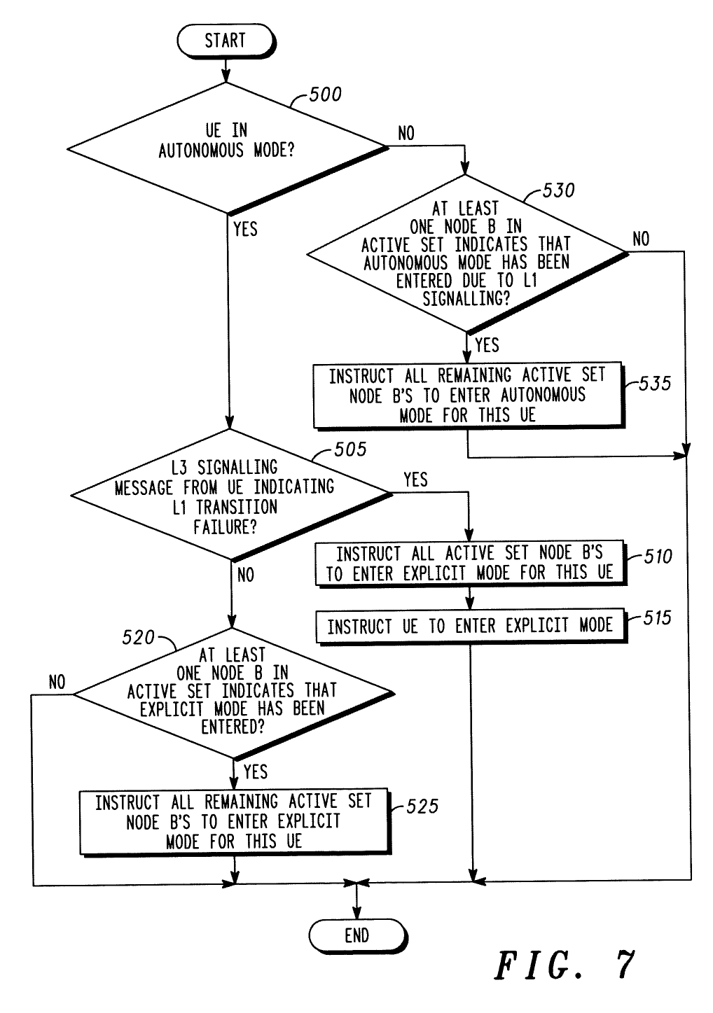

FIG. 7 is a flow diagram illustrating a method of operation of a radio network controller in accordance with a fifth aspect of the invention.

### DETAILED DESCRIPTION OF A PREFERRED EMBODIMENT

The present invention is concerned with the scheduling of uplink transmissions in a wireless communication system, and in particular with the management of transitions between an autonomous scheduling mode and an explicit scheduling mode for uplink transmissions from a wireless communication device to a base station in a wireless communication system.

Although the present invention is described with reference to a WCDMA system compatible with 3GPP specifications, it should be understood that the invention is not limited to such systems, but instead can be applied to uplink communications in other CDMA and TDMA wireless communication systems.

Thus in the following description the term “UE” is intended to refer to any suitable wireless communication device, the term “node B” is intended to refer to any base transceiver station, and the term “RNC” is intended to refer to any radio network controller, such as a base station controller. In addition, control signals and data described herein as being sent between the UE and the node B on specific channels appropriate to a WCDMA system compatible with 3GPP specifications may in other embodiments of the invention be sent on any suitable control and data channels available in other communication systems.

FIGS. 2a and 2b illustrate signaling exchanged between a wireless communication device (UE) and a base station (Node B) when an explicit scheduling mode is established for uplink data transfers, which will be used as the exemplary basis for the discussion of the invention below.

In the illustrated explicit scheduling mode, the UE sends scheduling information to the node B, for example on the proposed enhanced dedicated channel (E-DCH) uplink channel. The scheduling information includes, for example, an indication of the amount of data (also known as buffer occupancy) that the UE has to send on the uplink, and information about the UE power availability or power margin.

The node B responds to the scheduling information by scheduling one or more uplink transmissions for the UE and informs the UE of the scheduled uplink transmission timing in a scheduling assignment message (SAM) sent to the UE for example on the downlink dedicated channel or a high speed shared control channel (HS-SCCH). The SAM typically informs the UE of the allocated transmission time and also for example the maximum power that the UE is permitted to use for the uplink transmission.

At the scheduled time, the UE sends data to the node B on a first code channel together with Transport Format and Resource Indicator (TFRI) on a separate code channel. It is envisaged that the suggested enhanced dedicated channel may be used to send the data and TFRI: for example the suggested enhanced dedicated physical data channel (E-DPDCH) may be used by the UE to send the data to the node B and the suggested enhanced dedicated physical control channel (E-DPCCH) may be used for the TFRI data. However, any suitable uplink channels may be used.

The TFRI contains for example information relating to the actual amount of data sent and the coding and other information necessary for the node B correctly to interpret the received data. Typically, the TFRI will also include reliability information, such as cyclic redundancy check information, to enable the Node B to evaluate the reliability of the received TFRI information.

The steps set out above are repeated: thus periodically the UE sends scheduling information to the node B, the node B schedules one or more uplink transmissions and informs the UE of the scheduled transmission timing by way of a SAM.

FIG. 2b also illustrates signaling in accordance with an established autonomous scheduling mode for uplink data transfers, which will be used as the basis for the discussion of the invention below. Thus the description of the invention assumes that autonomous mode consists of uplink data transfer from the UE to the node B via the dedicated physical data channel (DPDCH) allocated to the UE with the rate being indicated by Transport Format Combination Indicator (TFCI) signaling carried on the associated dedicated physical control channel (DPCCH). However the method is valid for other variants of autonomous scheduling, for example where the data transfer occurs on the enhanced dedicated physical data channel (E-DPDCH).

The present invention will now be described with reference to FIGS. 3-7.

FIG. 3 is a flow diagram explaining the method of operation of a wireless communication device in accordance with a first aspect of the invention.

As indicated above, for the purposes of this description, it is assumed that the UE starts in the autonomous mode (100). In the autonomous mode, the UE is responsible for scheduling its transmissions on the uplink.

In the autonomous mode (100) the UE determines whether explicit scheduling is required. This determination may be made on the basis of the amount of data to be sent, as in the illustrative embodiment. However, the determination of scheduling mode may be made on the basis of other considerations, such as an application state, a desired quality of service, soft handover state or rate of increase in buffer occupancy.

Thus, in the illustrative embodiment, the UE determines whether explicit scheduling is required by monitoring the amount of data to be transmitted on the uplink, for example by comparing the number of bytes in the UE uplink transmission buffer with a threshold X (105). A suitable value of X may be determined in any manner that will occur to a skilled person. The value X may be static or may be varied dynamically, for example in response to an update received from the base station, based on received pilot information or power control information from all active set cells, based on SHO state of UE or based on the UE's current power margin. A suitable value of X may be in the range from 0 to 2000 bytes.

If the amount of data to be transmitted on the uplink is less than a predefined amount (105—no), the UE remains in the autonomous mode.

If, however, the amount of data to be transmitted on the uplink is more than a predefined amount (105—yes) it is desirable for the UE to move to an explicit scheduling mode. First a counter Ntx is initialized (110) and then a request for explicit scheduling is transmitted and the counter Ntx incremented. In FIG. 3 the transmission of the request for explicit scheduling is represented as the transmission of an EXPLICIT_REQ message (115) followed by the transmission of scheduling information, such as the amount of data the UE needs to send and the power margin available to the UE (120).

However, clearly, in other embodiments of the invention, different signaling may be employed by the UE in order to request explicit scheduling. For example, the scheduling information may be included as part of the EXPLICIT_REQ message, so that the request for explicit scheduling and the information necessary to carry out the scheduling are received together. Alternatively, it may be possible simply to send an initial scheduling information message, possibly in a slightly modified format from the normal scheduling information messages, in some embodiments where the receipt of such a message is interpreted by the node B as an implicit request for explicit scheduling.

The EXPLICIT_REQ message and/or the scheduling information can be transmitted on any suitable uplink channel appropriate to the communication system. In the illustrative embodiment, the EXPLICIT_REQ is sent on an enhanced dedicated channel E-DCH proposed for a WCDMA system compliant with 3GPP specifications, but this is not essential and EXPLICIT_REQ might also be transmitted on any dedicated channel allocated to the UE for example or any suitable uplink channel. The EXPLICIT_REQ message is preferably a pre-defined bit pattern that does not closely match any other transmission on the respective uplink channel, for example DCH.

The scheduling information is preferably sent on the enhanced dedicated channel (E-DCH) or the dedicated physical channel (DCH) in the illustrative embodiment: again, however, any suitable uplink channel may be used.

Once the request for explicit scheduling has been sent, the UE waits for receipt of a valid scheduling assignment message (SAM) from at least one of the node Bs in the active set of the UE (125). Clearly, as will be apparent to a skilled person, if the UE is in soft handover, the UE will have more than one node B in the active set: in contrast, if the UE is not in soft handover, the UE will have only one node B in its active set. The SAM is preferably received on the downlink dedicated channel or a high speed shared control channel (HS-SCCH) in the illustrative embodiment of the invention: however, any suitable downlink channel may be used.

The receipt of a valid SAM from a node B on the UE active list (125—yes) acts as an implicit acknowledgement and acceptance by the node B of the request for explicit scheduling sent by the UE. Thus on receipt of the valid SAM, the UE moves into the explicit scheduling mode (130).

As indicated above, the UE moves into explicit scheduling mode on receipt of a valid SAM from any node B in the active set, ensuring a rapid transition into the desired scheduling mode for the UE. As indicated above, if the UE is in soft handover, there will be more than one node B in the active set and so the possibility exists that one or more of the other node Bs in the active set will not have received the request for explicit scheduling owing to poor link quality. As will be explained below with respect to FIG. 7, in the illustrative embodiment any node Bs in the active set that have not received signaling direct from the UE, for example because of poor link quality between the UE and that Node B, are transitioned to the explicit scheduling mode by the RNC using higher level signaling.

In the explicit scheduling mode (130), as explained with reference to FIG. 2 above, the UE periodically sends scheduling information on the proposed enhanced dedicated channel (E-DCH) or the existing dedicated channel (DCH) for example the amount of data the UE currently needs to send and the power margin available to the UE. The UE receives SAMs from one or more active list node Bs on a dedicated channel (DCH) or high speed shared control channel (HS-SCCH) and subsequently transmits data on the uplink using the power/timing information received in the SAM. As explained above in connection with FIG. 2, the UE transmits one code channel containing the data together with a code channel containing the TFRI, which provides the node B with information about the format of the data.

If however a valid SAM is not received (125—no) the UE repeats the request over a period of time. A suitable period of time may be of the order of 10 ms. In the illustrated embodiment this is achieved by the initialization of the counter in step 110 and the comparison of counter Ntz with a threshold Nthresh to determine whether sufficient explicit scheduling request attempts have been made (135). However it should be noted that the repetition over a period of time may be achieved by other means, for example by means of a timer, as will be apparent to a skilled person.

If sufficient explicit scheduling request attempts have not been made (135—no), the UE transmits a further explicit scheduling request (115, 120). However, if sufficient explicit scheduling request attempts have been made (135—yes), the UE may simply return to the autonomous mode (not shown). Preferably, however, as shown in the illustrative embodiment, the UE sends a message to the RNC using L3 RNC/UE signaling informing the RNC of the L1 layer transition failure (140). For example, in the illustrative WCDMA system, such RNC/UE signaling can be carried on the dedicated physical data channel (DPDCH) allocated to the UE: however it will be clear that any suitable uplink channel may be used.

After the UE has informed the RNC of the L1 transition failure, the UE determines whether the RNC returns a message using L3 RNC/UE signaling instructing the UE to transition to explicit scheduling (145), as will be explained below with reference to FIG. 7. If such a message from the RNC is received (145—yes), the UE moves to the explicit scheduling mode (130), and starts sending scheduling information as shown in FIG. 2.

Clearly, it may in some circumstances be advantageous for the node B or the RNC to be able to force the UE into an explicit scheduling mode. In some embodiments, therefore, the UE may receive a message instructing the UE to transition to explicit scheduling (145) without UE first having informed the RNC of a failed scheduling mode transition (140).

Alternatively, although preferable, it is not necessary in all embodiments for the UE to wait for confirmation from the RNC prior to moving to the explicit scheduling mode (130). For example, the UE could move straight to the explicit scheduling mode (130) after informing the RNC of the explicit scheduling mode request (140) (not shown).

Alternatively, after informing the RNC of the failure to transition to the explicit scheduling mode using L1 signaling (140) the UE could retransmit the scheduling information (step 120) until a valid SAM from at least one active set node B is received (125) before entering the explicit mode (130). In this arrangement, the receipt of the valid SAM acts as an implicit acknowledgement that the node B has correctly been instructed by the RNC to enter explicit mode, in response to the RNC/UE L3 signaling.

The operation of the RNC on receipt of the message from the UE will be described in more detail with reference to FIG. 7.

The operation of the node B in transition between autonomous scheduling mode and explicit scheduling modes will now be explained with reference to FIG. 4.

As indicated above, for the purposes of this description, it is assumed that the node B starts in the autonomous mode (200). In the autonomous mode, the UE is responsible for scheduling its transmissions on the uplink, and the node B merely receives data and associated TFCI signaling from the UE.

In the autonomous mode, the node B checks whether a message is received from the RNC instructing a change of state to the explicit mode (205). On receipt of such a message (205—yes) the node B informs the RNC that the node B is transitioning to the explicit scheduling mode for the UE (210) and then enters the explicit scheduling mode (215), which will be described in more detail hereafter. It should be noted that it is not necessary in all embodiments for the node B to inform the RNC that the transition to the explicit scheduling mode instructed by the RNC has been accomplished. Thus, in alternative embodiments (not illustrated) the node B may transition straight to the explicit scheduling mode 215 in response to the receipt of the RNC message 205.

The node B also checks whether an explicit scheduling request is received from the UE. In the illustrated embodiment, the node B first checks whether an EXPLICIT_REQ message is received from the UE (220) and then whether scheduling information is received from the UE (225). However, clearly in other embodiments, for example where the scheduling information is contained within the EXPLICIT_REQ message, or where receipt of a differently formatted scheduling information message is interpreted as an explicit scheduling request, separate steps 220 and 225 are not necessary. If the explicit scheduling request message is not received (220—no or 225—no) the node B remains in the autonomous mode (200). Once an explicit scheduling request is received (220—yes, 225—yes) the node B schedules the uplink transmission and sends a SAM to the UE (230).

In the illustrated embodiment, the node B then determines whether another explicit scheduling request or EXPLICIT_REQ message is received from the UE (235). If another EXPLICIT_REQ message is received from the UE (235—yes), the node B infers that the UE did not receive the SAM sent previously and so re-schedules the requested uplink transmission from the UE and sends an updated SAM to the UE (230).

Otherwise (235—no), the node B determines whether a TFRI has been validly received from the UE at the expected scheduled uplink transmission time interval (240). This may be achieved, for example, in the illustrative embodiment in which a cyclic redundancy check (CRC) is employed as a validity indicator for the TFRI by determining whether the TFRI has been received with a good CRC. If not (240—no) the node B can infer either that the detection of the explicit scheduling request was erroneous and no explicit scheduling request was made, or that the UE has not received the SAM and is not in explicit scheduling mode or that the interference on the uplink is such that the data is not being received correctly by the node B. In either case, the node B returns to the autonomous mode for the UE (100).

If, however, the node B determines that a valid TFRI with a good CRC is received from the UE at the expected scheduled uplink transmission time (240—yes) the node B can infer that the UE has received and responded to the SAM and that the uplink conditions are such that the data is being received reliably by the node B. Since the node B can infer that the UE is in explicit scheduling mode and that the explicit scheduling mode is operating correctly, the node B informs the RNC that the UE is transitioning to the explicit scheduling mode (210) and then enters explicit scheduling mode (215). This also indicates to the RNC that the node B is now responsible for radio resource management for the UE uplink transmissions. The operation of the RNC in response to this message will be described below with reference to FIG. 7.

In the explicit scheduling mode, as discussed above with reference to FIG. 2, the node B periodically receives scheduling information from the UE. As explained above, the scheduling information comprises for example information about the amount of data that the UE has to send and the power margin of the UE. The node B schedules an uplink transmission time for the UE based on the scheduling information received from the UE and on other information such as likely interference for uplink transmissions from the UE, and sends a SAM to the UE to inform the UE of the scheduled transmission time. At the scheduled transmission time, the node B receives the transmitted data on a first code channel and the TFRI on a second channel. Preferably a validity check, such as a cyclic redundancy check, is made on the received TFRI and if a good result is obtained, for example the CRC passes, the explicit scheduling is considered to be operating correctly.

The operation of a UE during transition of the UE from explicit scheduling mode to autonomous mode is explained with reference to FIG. 5.

As explained above, during the explicit scheduling mode (300) the UE periodically transmits scheduling information comprising for example the amount of data that the UE has to send (buffer occupancy) and the power margin of the UE and periodically receives SAMs informing the UE of the scheduled uplink transmission time. At the scheduled uplink transmission time, the UE decides how much of the data to send and at what power level (within the limits imposed by the node B in the SAM) and sends the data on code channel E-DCH, in the illustrative embodiment. In addition, the UE also sends simultaneously accompanying TFRI, comprising information relating to the amount of data and the rate at which it has been sent, on a second code channel E-DPCCH, in the illustrative embodiment. The TFRI also preferably includes a validity check, for example a cyclic redundancy check in the illustrative embodiment.

During the explicit scheduling mode (300), the UE monitors whether an explicit scheduling condition exists. For example, in the illustrated embodiment, the UE monitors whether an explicit scheduling condition exists by monitoring the amount of data to be sent (305), for example by determining whether the amount of data in the UE output buffer is more than a threshold value Y. The threshold value Y may be the same value as the threshold value X used during the transition from the autonomous mode or may be a different value.

The use of a threshold value Y in 305 that is lower than the threshold value X in 105 provides a degree of hysteresis in the transitions between the autonomous mode and the explicit scheduling mode.

Additionally or alternatively, hysteresis in the transitions between the autonomous mode and the explicit scheduling mode may be provided by use of a timer as shown in the illustrated embodiment, which will be explained further below.

Hysteresis in the transitions between the autonomous mode and the explicit scheduling mode advantageously prevents a too rapid oscillation between the autonomous mode and the explicit scheduling mode. For example, when the UE is in soft handover and thus has more than one node B in its active set, some time, typically of the order of 500 ms, is necessary to ensure that all the active set node Bs have been updated to the new mode of operation. This updating may be achieved via the RNC, as will be described below. Thus, hysteresis in transitions between the autonomous mode and the explicit scheduling mode ensures that all node Bs are kept synchronized with the UE.

Alternatively, if the UE is sending bursty data, the provision of hysteresis is particularly advantageous owing to the averaging effect provided by the hysteresis. Thus the UE will remain in the explicit scheduling mode even though during that time interval the amount of data to be sent by the UE may not be sufficient to justify the explicit scheduling mode. If another burst of data arrives in the UE transmit buffer, the UE is correctly in explicit scheduling mode, which is the most effective mode for transmitting large amounts of data on the uplink. Without the hysteresis, the UE would have transitioned to autonomous mode and would need to transition back to the explicit scheduling mode when the new burst of data arrived, with the associated signaling overhead.

This hysteresis may be provided by means of a first timer, as described in the illustrative embodiment. However the application state and/or quality of service (QoS) may be used to initiate or maintain the explicit scheduling mode. Alternatively or additionally, the rate of change of or increase in buffer occupancy may be used.

The initial values of threshold X and of threshold Y, if used, and the timer settings may be set at call initiation.

Thus, in the illustrated embodiment, if the amount of data to be sent justifies the use of the explicit scheduling mode (305—yes) a first timer is reset (310) and the explicit scheduling mode is continued (300).

If, however, the amount of data to be sent falls below the amount justifying the continuation of the explicit scheduling mode, the UE determines whether the first timer has expired (315). Until the first timer has expired (315—yes) the UE checks whether the amount of data justifies the use of explicit scheduling (305). If during the time the timer is un-expired sufficient data is added to the UE transmit buffer to justify explicit scheduling (315—no, 305—yes) the timer is reset (310) and the UE remains in explicit scheduling mode (300). If, however, the timer expires without the amount of data justifying explicit scheduling, (315—yes) the UE sends an autonomous mode notification message to the active set node Bs (320), for example by transmitting an AUTONOMOUS_IND message on the enhanced dedicated channel (E-DCH) in the illustrative embodiment.

The autonomous mode notification message may be repeated over a period of time, say 10 ms, to improve the probability that the or any of the node Bs will receive the autonomous mode notification message. The repetition may be achieved by means of a timer or a counter or in any other way that may occur to a skilled person.

Alternatively or additionally, the system may be arranged such that the node B acknowledges receipt of an autonomous mode notification message by sending an ACK to the UE (not shown). Thus the UE may keep sending the autonomous mode notification message until an ACK is received from the or at least one node B.

Thereafter, the UE enters autonomous mode (325) and operates in the autonomous mode as described above.

FIG. 5a shows an alternative embodiment in which a second timer is used to determine if the UE should leave explicit mode (300) and enter the autonomous mode (325). In FIG. 5a if a second timer has not expired (317—no) then the UE checks if a new scheduling assignment has been received (318). If a new SAM has been received (318—yes) then timer 2 is reset (319) otherwise the timer is not reset (318—no). In either case the UE then checks whether the amount of data justifies the use of explicit scheduling (305) and proceeds as described above with reference to FIG. 5. If the second timer has expired (317—yes) then the UE sends an autonomous mode notification message to the active set node Bs (320), for example by transmitting an AUTONOMOUS_IND message on the enhanced dedicated channel (E-DCH) in the illustrative embodiment.

The operation of a node B during transition of the node B from explicit scheduling mode to autonomous mode is explained with reference to FIG. 6.

The node B starts in explicit scheduling mode (400) in which the node B is receiving scheduling information from the UE, scheduling an uplink transmission time for the UE, sending a SAM to the UE, and receiving an uplink transmission from the UE at the scheduled time.

While in the explicit scheduling mode, the node B monitors whether a message is received from the RNC instructing the node B to change to the autonomous mode (405). If the node B receives such a message from the RNC (405—yes), the node B transitions to the autonomous mode (410).

If no such message is received by the node B (405-n), the node B determines whether the UE is still operating in the explicit scheduling mode of operation. The node B accomplishes this for example by monitoring for receipt of an AUTONOMOUS_IND message on the enhanced dedicated channel E-DCH from the UE (410).

Preferably, the node B also monitors the TFRI messages received from the UE (415). The monitoring of the TFRI messages may act firstly as a quality check i.e. a validity check, for example the cyclic redundancy check of the illustrated embodiment, carried out on the TFRI message may indicate an unexpected and unacceptably high level of interference. Secondly, the check on the TFRI message can act as an implicit indication that the UE has dropped out of the explicit scheduling mode and into the autonomous mode because a UE in the autonomous mode will not be transmitting the data/TFRI messages at the expected time in response to a SAM.

If no AUTONOMOUS_IND message is received (410—no) and the TFRI messages are being received from the UE with sufficient quality (415—yes) all is assumed to be well with the explicit scheduling and the node B remains in explicit scheduling mode (400).

If, however, either an AUTONOMOUS_IND message is received (410—yes) or in the illustrated embodiment it is determined that the TFRI messages are being received from the UE with insufficient quality (415—no) the node B informs the RNC that the node B is transitioning to the autonomous mode (420). If the transition may be triggered by insufficient received quality, as shown in the illustrated embodiment, the node B preferably informs the RNC of the reason for the transition. Thereafter, the node B transitions to the autonomous mode (410).

The operation of the radio network controller (RNC) in an embodiment of the invention will now be described with reference to FIG. 7.

From the preceding description, it will be understood that the role of the RNC is preferably two-fold: firstly, when the UE is to transition between the autonomous mode and the explicit scheduling mode, the UE/RNC L3 communication path provides a fail-safe route to inform the node Bs in the active set that the UE requires explicit scheduling. Secondly the RNC coordinates the autonomous mode/explicit scheduling mode transitions of all node Bs in the active set of a UE to ensure that the mode of all node Bs in the active set are updated irrespective of whether the node B receives the relevant L1 signaling from the UE.

The operation of the RNC depends on whether or not the UE is currently in the autonomous mode. If the UE is in the autonomous mode (500—yes), the RNC determines whether the UE wishes to transition to the explicit scheduling mode and whether any/all node Bs on the UE active set require updating to the explicit scheduling mode.

Thus, when the UE is in autonomous mode (500—yes) the RNC monitors whether the RNC receives a message from the UE indicating that the UE has been unsuccessful in the L1 communication of explicit scheduling mode request to the active set node Bs (505). Preferably this is a direct L3 message from the UE to the RNC, such as the messages carried on the dedicated control channel DCCH in a Release 6 3GPP-compliant system. This L3 message is the message sent by the UE described above with reference to step 140. If such a L3 message is received by the RNC (505—yes) the RNC first instructs all active set node Bs to enter the explicit scheduling mode (step 510) and then instructs the UE to enter explicit scheduling mode (step 515).

The receipt by the node B(s) of the RNC instruction to the node B(s) sent in step 510 has been described above with reference to step 205 of FIG. 3. As described above, after receipt of the instruction to change state in step 205, the node B may confirm to the RNC the transitioning to the explicit scheduling mode in step 210. In such an arrangement, the RNC may perform an additional step (not shown in FIG. 7) of checking whether confirmation has been received from all active set node Bs, and repeating step 510 until confirmation of the transition to explicit scheduling mode has been received from all active set node Bs. However, embodiments are envisaged in which no confirmation of the transition to explicit scheduling mode is provided by the node B to the RNC, so that, for example, the receipt of the RNC message in step 205—yes leads directly to the establishment of the explicit scheduling mode in step 215.

The RNC instructs the UE to enter the explicit scheduling mode (515) using L3 signaling, such as the messages carried on the dedicated control channel DCCH channel in a Release 6 3GPP-compliant system. This message corresponds to the message received by the UE in step 145 in FIG. 3 and leads to the establishment of the explicit scheduling mode in the UE. As indicated above with reference to FIG. 3, it is not necessary for such a RNC/UE L3 message to be sent (step 515 FIG. 7) and received (step 145 FIG. 3).

The UE and all node Bs in the active set of the UE are now in the active scheduling mode.

While the UE is in the autonomous mode (500—yes) the RNC also monitors whether the RNC receives a message from at least one node B in the active set of the UE indicating that the node B has entered explicit scheduling mode for the UE.

As described above, if the explicit scheduling mode is initiated by the safe receipt of an explicit scheduling request message by at least one of the active set node Bs, the node B will inform the RNC that the explicit scheduling mode has been established via the message described above with reference to step 210 of FIG. 4.

On receipt of such a message when the UE is in the autonomous mode (500—yes, 520—yes) the RNC instructs all remaining active set node Bs to enter the explicit scheduling mode (step 525). This ensures that all active set node Bs are made aware of the transition of the UE to explicit scheduling mode, whether or not they have received L1 signaling direct from the UE.

The receipt by the remaining node B(s) of the RNC instruction to the node B(s) sent in step 525 has been described above with reference to step 205 of FIG. 4. As described above, after receipt of the instruction to change state in step 205, the node B may confirm to the RNC the transitioning to the explicit scheduling mode in step 210 or may move directly to the explicit scheduling mode state in step 215 FIG. 4.

In such an arrangement, the RNC may perform an additional step (not shown in FIG. 7) of checking that whether confirmation has been received from all active set node Bs, and repeating step 525 until confirmation of the transition to explicit scheduling mode has been received from all remaining active set node Bs. However, embodiments are envisaged in which no confirmation of the transition to explicit scheduling mode is provided by the node B to the RNC, so that, for example, the receipt of the RNC message in step 205—yes leads directly to the establishment of the explicit scheduling mode in step 215.

Since it is clear from a consideration of FIGS. 3 and 4 that the message from the node B to the RNC received by the RNC in step 520 cannot have been sent by the node B in step 210 without implicit confirmation that the UE has transitioned to the explicit scheduling mode, it is not necessary for the RNC to instruct the UE to enter the explicit scheduling mode, and so the RNC need take no further action.

If neither the L3 message from the UE nor the explicit scheduling mode message from a node B is received (505—no, 520—no) the RNC takes no action and resumes monitoring (500)

If the UE is in explicit scheduling mode (500—no) the RNC determines whether at least one node B in the active set indicates that the autonomous mode has been entered due to L1 signaling (530). This message is the message sent by a node B to the RNC in step 420 of FIG. 3 in response to the node B detection of the AUTOMOMOUS_IND message from the UE.

If no node B indicates that the autonomous mode has been entered (530—no) no action is taken. If, however, at least one node B indicates that it has entered autonomous mode owing to L1 signaling i.e. in the described embodiment as a result of the receipt of an AUTONOMOUS_IND message from the UE (530—yes) the RNC instructs all remaining node Bs in the active set for that UE to enter autonomous mode (535).

The action taken by a node B on receiving the RNC instruction sent in step 535 has been described above with reference to step 405 in FIG. 6. Thus each remaining node B also transitions to the autonomous mode on the instructions of the RNC, resulting in the UE and all node Bs in the UE active set being in the autonomous mode.

Additionally or alternatively the RNC may force the UE and the or all of the node Bs in the active set of the UE into the autonomous or explicit scheduling modes via higher layer signaling in response to higher layer messages received from the or any of the node Bs in the active set of the UE.

Additionally or alternatively, switching between explicit and autonomous mode may also be dependent upon the power margin left at the UE or the Rise over Thermal (ROT) at the node B. Advantageously the UE should switch to autonomous mode in situations where the power margin at the UE is below a certain threshold and/or if the ROT exceeds a certain threshold.

In addition it should be noted that while the UE is in the autonomous mode or, less likely, while the UE is in the explicit scheduling mode, higher level signaling in accordance with 3GPP R99/R5/R6 specifications can move the UE to the CELL_FACH state (not shown). In the CELL_FACH state communication is initiated by means of a random access procedure and neither autonomous nor explicit scheduling is used.

In one embodiment (not shown) the UE may also determine whether a negative acknowledgement of the explicit scheduling request (NAK_ES) is received from any node B in the active set of the UE. This situation might arise if the node B is unable to provide the explicit scheduling requested, for example because insufficient capacity exists or there is excessive interference. In this situation the UE returns to the autonomous mode.

Thus the present invention provides an advantageous method for transitioning reliably between scheduling modes on an uplink in a wireless communication system. Transitions between scheduling modes are effected as far as possible using L1 signaling between a wireless communication device and a base station, providing low delay transitions in the majority of cases.

Advantageously, if L1 signaling fails, L3 signaling direct between the wireless communication device and a network control element may be employed. In addition, the method may operate effectively even when the wireless communication device is in communication with a number of base stations in a soft handoff situation because the network control element may act to ensure that all base stations are updated to correspond to the current scheduling mode employed by the wireless communication device.

1. A method of operation in a wireless communication device capable of operating in a first mode in which the wireless communication device schedules uplink transmissions and a second mode in which a base station schedules uplink transmissions, wherein when the wireless communication device is operating in the first mode the method comprising the steps:
determining whether operation in accordance with the second mode is required;
in response to a determination that operation in accordance with the second mode is required, sending a request for scheduling of uplink transmissions to the or at least one serving base station;
entering the second mode if a scheduling message is received from the base station.

2. The method of operation of a wireless communication device as claimed in claim 1 comprising the steps of sending a message requesting second mode operation to a network controller if a scheduling message is not received from the base station.

3. The method of operation of a wireless communication device as claimed in claim 2 further comprising the step of entering the second mode of operation in response to a message from the network controller.

4. The method of operation of a wireless communication device as claimed in claim 1, wherein the step of determining whether operation in accordance with the second mode is required comprises the step of determining the amount of data to be sent.

5. The method of operation of a wireless communication device as claimed in claim 1, wherein the step of determining whether operation in accordance with the second mode is required comprises the step of determining the buffer occupancy of the wireless communication device.

6. The method of operation of a wireless communication device as claimed in claim 1, wherein the step of determining whether operation in accordance with the second mode is required comprises the step of determining the rate of change in buffer occupancy of the wireless communication device.

7. The method of operation of a wireless communication device as claimed in claim 1 wherein the step of determining whether operation in accordance with the second mode is required comprises the step of determining the application state and/or quality of service associated with data to be sent.

8. The method of operation of a wireless communication device as claimed in claim 1 wherein the step of determining whether operation in accordance with the second mode is required comprises the step of determining the power margin of the wireless communication device.

9. The method of operation of a wireless communication device as claimed in claim 1 wherein the step of sending a request for scheduling of uplink transmissions to the or at least one serving base station comprises the step of sending a scheduling information message.

10. The method of operation of a wireless communication device as claimed in claim 9 wherein the format of the scheduling information message acts as an implicit request for scheduling of uplink transmissions.

11. The method of operation of a wireless communication device as claimed in claim 1 wherein the step of entering the second mode if a scheduling message is received from the base station comprises the step of entering the second mode if a scheduling message assigning the wireless communication device at least a time for uplink transmission.

12. The method of operation of a wireless communication device as claimed in claim 1, further comprising the step of remaining in the first mode if a message refusing the establishment of the second mode of operation is received from the base station.

13. A method of operation in a wireless communication device capable of operating in a first mode in which the wireless communication device schedules uplink transmissions and a second mode in which a base station schedules uplink transmissions, wherein when the wireless communication device is operating in the first mode the method comprising the steps:
determining whether operation in accordance with the second mode is required;
in response to a determination that operation in accordance with the second mode is required, sending a message to the or at least one serving base station requesting scheduling of uplink transmissions;
sending a message requesting second mode operation to a network controller if a scheduling message is not received from the base station.

14. The method of operation of a wireless communication device as claimed in claim 13 comprising the steps of sending a message requesting second mode operation to a network controller if a scheduling message is not received from the base station.

15. The method of operation of a wireless communication device as claimed in claim 13, wherein the step of determining whether operation in accordance with the second mode is required comprises the step of determining the amount of data to be sent.

16. The method of operation of a wireless communication device as claimed in claim 13 wherein the step of determining whether operation in accordance with the second mode is required comprises the step of determining the application state and/or quality of service associated with data to be sent.

17. The method of operation of a wireless communication device as claimed in claim 13 wherein the step of determining whether operation in accordance with the second mode is required comprises the step of determining the power margin of the wireless communication device.

18. The method of operation of a wireless communication device as claimed in claim 13 wherein the step of sending a request for scheduling of uplink transmissions to the or at least one serving base station comprises the step of sending a scheduling information message.

19. The method of operation of a wireless communication device as claimed in claim 13 wherein the format of the scheduling information message acts as an implicit request for scheduling of uplink transmissions.

20. The method of operation of a wireless communication device as claimed in claim 13, further comprising the step of remaining in the first mode if a message refusing the establishment of the second mode of operation is received from the base station.

21. The method of operation of a wireless communication device as claimed in claim 13 further comprising the step of entering the second mode of operation in response to a message from the network controller.

22. A method of operation in a wireless communication device capable of operating in a first mode in which the wireless communication device schedules uplink transmissions and a second mode in which a base station schedules uplink transmissions, wherein when the wireless communication device is operating in the second mode the method comprising the steps:
determining whether operation in accordance with the first mode is required;
in response to a determination that operation in accordance with the first mode is required, sending a first mode notification message to the or at least one serving base station;
transitioning to the first mode.

23. The method of operation in a wireless communication device as claimed in claim 22 wherein the step of determining whether operation in accordance with the first mode is required comprises the step of determining the amount of data to be sent.

24. The method of operation of a wireless communication device as claimed in claim 22 wherein the step of determining whether operation in accordance with the first mode is required comprises the step of determining the application state and/or quality of service associated with data to be sent.

25. The method of operation of a wireless communication device as claimed in claim 22 wherein the step of determining whether operation in accordance with the first mode is required comprises the step of determining the power margin of the wireless communication device.

26. The method of operation of a wireless communication device as claimed in claim 22 wherein step of transitioning to the first mode is delayed to provide hysteresis.

27. A method of operation of a base station serving a wireless communication device, the base station being capable of operating in a first mode in which the wireless communication device schedules uplink transmissions and a second mode in which the base station schedules uplink transmissions, wherein when the base station is in the first mode the method comprises the steps:
receiving a request for second mode operation from the wireless communication device;
scheduling an uplink transmission responsive to the request for second mode operation
transitioning to the second mode if a valid uplink transmission is received from the wireless communication device at the scheduled time.

28. The method of operation of a base station in accordance with claim 27 further comprising the step of informing a network controller of the transition to the second mode.

29. The method of operation of a base station in accordance with claim 27 further comprising the steps of:
determining whether a message is received from a network controller instructing the base station to transition to the second mode of operation; and
transitioning to the second mode of operation in response to the received message.

30. A method of operation of a base station serving a wireless communication device, the base station being capable of operating in a first mode in which the wireless communication device schedules uplink transmissions and a second mode in which the base station schedules uplink transmissions, wherein when the base station is in the second mode the method comprises the steps:
determining whether a first mode notification message is received from the wireless communication device;
transitioning to the first mode of operation on receipt of a first mode notification message from the wireless communication device.

31. A method of operation of a base station as claimed in claim 30 further comprising the step of informing a radio network controller of the transition to the first mode on receipt of the first mode notification message.

32. A method of operation of a base station as claimed in claim 30 further comprising the step of determining whether a message is received from a radio network controller instructing the base station to transition to the first mode of operation; and the step of transitioning to the first mode if such an instruction is received.

33. A method of operation of a base station as claimed in claim 30 further comprising the step of determining whether valid expected uplink transmissions scheduled by the base station are being received from the wireless communication device; and transitioning to the first mode if valid expected uplink transmissions are not being received.

34. A method of operation of a base station as claimed in claim 33 further comprising the step of informing a radio network controller of the transition to the first mode owing to the failure to receive valid expected uplink transmissions.

35. A method of operation of a base station serving a wireless communication device, the base station being capable of operating in a first mode in which the wireless communication device schedules uplink transmissions and a second mode in which the base station schedules uplink transmissions, wherein when the base station is in the second mode the method comprises the steps:
determining whether a message is received from a radio network controller instructing the base station to transition to the first mode of operation; and
transitioning to the first mode if such an instruction is received.

36. Method of operation of a radio network controller in a wireless communication system, the wireless communication system having at least one base station that, in use, provides communication services to at least one wireless communication device, the at least one base station and the at least one wireless communication device being operable in a first mode in which the wireless communication device schedules uplink transmissions and a second mode in which the base station schedules uplink transmissions, comprising the steps:
determining receipt of a message from a wireless communication device in the first mode requesting transition to the second mode; and
instructing all base stations associated with the wireless communication device to transition to the second mode in response to the receipt of said message.

37. Method of operation of a radio network controller as claimed in claim 36 further comprising the step of instructing the wireless communication device to transition to the second mode.

38. Method of operation of a radio network controller in a wireless communication system, the wireless communication system having at least one base station that, in use, provides communication services to at least one wireless communication device, the at least one base station and the at least one wireless communication device being operable in a first mode in which the wireless communication device schedules uplink transmissions and a second mode in which the base station schedules uplink transmissions, comprising the steps:
determining receipt of a message from a base station associated with a wireless communication device indicating that the wireless communication device has entered the first or the second mode; and
instructing any other base stations associated with the wireless communication device that the wireless communication device has entered the first or second mode.

39. The method of operation of a radio network controller in a wireless communication system as claimed in claim 38 further comprising the steps of:
determining receipt of a message from a wireless communication device in the first mode requesting transition to the second mode; and
instructing all base stations associated with the wireless communication device to transition to the second mode response to the receipt of said message.

40. Method of operation of a radio network controller as claimed in claim 38 further comprising the step of instructing the wireless communication device to transition to the second mode.
